(19) United States
(12) Patent Application Publication
(10) Pub. No.: US 2026/0115512 A1
(43) Pub. Date: Apr. 30, 2026

(54) ELECTRIC VEHICLE CHARGING SYSTEM

(71) Applicant: Sergej Marojevic, Watauga, TX (US)

(72) Inventor: Sergej Marojevic, Watauga, TX (US)

(21) Appl. No.: 19/373,142

(22) Filed: Oct. 29, 2025

Related U.S. Application Data
(60) Provisional application No. 63/713,167, filed on Oct. 29, 2024.

(51) Int. Cl. A62C 3/16; A62C 37/00; B60L 53/30; B60L 53/68

(52) U.S. Cl. CPC A62C 3/16; A62C 37/00; B60L 53/305; B60L 53/68

(57) ABSTRACT

Disclosed are example embodiments of systems and methods for an electric vehicle charging system that includes a charging station configured to provide electrical energy to an electric vehicle, an artificial-intelligence facial recognition camera communicatively coupled to the charging station and configured to capture a facial image of a user for authentication, and a controller configured to enable charging based on a comparison between a facial feature vector derived from the captured image and stored feature data of a registered user. The system further includes a fire suppression subsystem integrated within the charging station and configured to discharge an aerosol-based extinguishing agent into an interior volume when a thermal condition indicative of a fire is detected. In some embodiments, the fire suppression subsystem employs a hot-aerosol composition that provides endothermic cooling and chemical inhibition, enabling autonomous safety protection during operation and maintaining charging functionality in both network-connected and offline conditions.

### CROSS-REFERENCE TO RELATED APPLICATION

This application claims priority to U.S. Provisional Patent Application No. 63/713,167, filed on Oct. 29, 2024, and entitled “AN ELECTRIC VEHICLE CHARGING SYSTEM WITH FSS AND AI INTEGRATION,” which is incorporated by reference herein in its entirety for all purposes.

### TECHNICAL FIELD

The present disclosure relates generally to electric vehicle charging technology, and more specifically, some embodiments relate to systems and methods for integrating artificial intelligence-based facial recognition and/or an automatic fire suppression system within electric vehicle charging infrastructure to enhance security, safety, and operational continuity.

### BACKGROUND

Electric vehicle (EV) charging technology continues to evolve as demand for reliable and efficient charging infrastructure increases. In many environments, user authentication and system activation require physical interaction or external devices such as identification cards or mobile applications. Such approaches may introduce potential vulnerabilities, inefficiencies, or delays in the charging process, particularly in unattended or high-traffic installations.

In addition, network connectivity interruptions may adversely affect the operation of some charging systems that depend on continuous communication with remote servers for authentication, payment processing, or control. Maintaining uninterrupted service under these conditions remains a technical challenge.

Furthermore, as charging power levels increase—especially with direct current fast charging (DCFC) equipment—thermal and electrical risks may arise, particularly in enclosed or confined installations. Integration of fire detection and suppression capabilities into the charging infrastructure can enhance safety and reduce the potential for damage.

Accordingly, there is a need for an electric vehicle charging system that provides secure, contactless user authentication, maintains functional continuity during network interruptions, and incorporates an intelligent fire suppression capability to improve safety and reliability. Some embodiments of the present disclosure address these needs by integrating artificial intelligence (AI)-based facial recognition with an automated fire suppression system within the charging station architecture.

### SUMMARY

Disclosed are example embodiments of an electric vehicle charging system that may include a charging station configured to provide electrical energy to an electric vehicle, an artificial-intelligence facial recognition camera communicatively coupled to the charging station and configured to capture a facial image of a user, a controller configured to compare a facial feature vector derived from the facial image to stored feature data associated with a registered user and to enable charging responsive to a positive match, and a fire suppression subsystem integrated within the charging station and configured to discharge an aerosol-based extinguishing agent into an interior volume when a thermal condition indicative of a fire event is detected. In some embodiments, the fire suppression subsystem may include a hot-aerosol device activated electrically or thermally and may employ both cooling and chemical inhibition to suppress combustion within enclosed spaces.

Disclosed are example embodiments of a method for operating an electric vehicle charging system comprising an artificial-intelligence facial recognition subsystem and a fire suppression subsystem. The method may include receiving a registration of a user including facial and vehicle data, capturing a live facial image of the user proximate to a charging station, generating a facial feature vector using a convolutional neural network, comparing the facial feature vector to stored feature data, enabling charging responsive to a positive match, and activating the fire suppression subsystem to discharge an aerosol extinguishing agent when a fire condition is detected within or near the charging station. Additional embodiments may include storing transaction data locally during network interruption, synchronizing data when connectivity is restored, and transmitting alerts to user and backend interfaces upon activation of the fire suppression subsystem.

Disclosed are example embodiments of a non-transitory computer-readable medium storing instructions that, when executed by one or more processors of an electric vehicle charging system, may cause the processors to process facial image data captured by an artificial-intelligence facial recognition camera to generate a facial feature vector, compare the facial feature vector to stored data to determine user identity, enable a charging function responsive to successful identification, and monitor environmental parameters to initiate activation of a fire suppression subsystem when a thermal condition exceeds a threshold. The instructions may further cause execution of anti-spoofing analysis, local caching and synchronization of transaction data, and issuance of user-facing and backend alerts associated with charging and fire suppression operations.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a diagram that illustrates an example embodiment of an electric vehicle charging system including an artificial intelligence facial recognition camera, a charging station, and a fire suppression subsystem in accordance with the systems and methods described herein.

FIG. 2A is a flowchart that illustrates an example embodiment of a facial registration workflow for capturing and storing user facial data in accordance with the systems and methods described herein.

FIG. 2B is a flowchart that illustrates an example embodiment of a facial recognition workflow for authenticating a user and enabling a charging session in accordance with the systems and methods described herein.

FIG. 3 is a diagram that illustrates an example embodiment of a system architecture showing integration of the device layer, service layer, infrastructure layer, and application layer within the charging system in accordance with the systems and methods described herein.

FIGS. 4A-4C are diagrams that illustrate example embodiments of physical integration of the artificial intelligence camera, illumination components, and fire suppression subsystem within a charging station in accordance with the systems and methods described herein.

FIGS. 5A-5C are diagrams that illustrate example embodiments of a cable secured compartment extension configured for integration with a direct current fast-charging (DCFC) station, showing respective views of a secured compartment housing, internal cable arrangement, and locked configuration in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The following detailed description describes example embodiments of an intelligent electric vehicle charging system that integrates an artificial intelligence-based facial recognition subsystem with an automatic fire suppression subsystem. The described embodiments are provided to enable those skilled in the art to make and use the disclosed subject matter and are not intended to limit the scope of the claims. Features described in connection with one embodiment may be used with other embodiments unless otherwise stated.

### System Overview

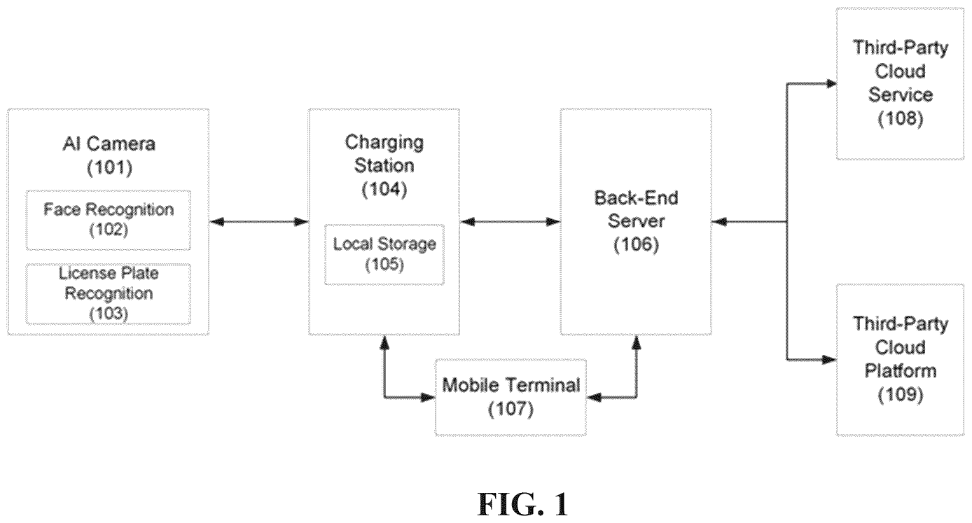

FIG. 1 is a diagram that illustrates an example embodiment of an electric-vehicle charging system incorporating an artificial-intelligence (AI) camera, a charging station, and cloud-connected components in accordance with the systems and methods described herein. The architecture may be described in logical layers—including device, service, infrastructure, and application layers—which cooperate to provide authentication, charging control, and safety management, although these layers are shown conceptually and are not assigned reference numerals.

Referring to FIG. 1, an AI camera 101 may include a facial-recognition module 102 and, in some embodiments, a license-plate-recognition module 103. The AI camera 101 may be communicatively coupled to a charging station 104 that includes a local-storage component 105 configured to retain authentication or transaction data during network interruptions. The charging station 104 may exchange data with a backend server 106 responsible for authorization, billing, and system coordination.

A mobile terminal 107 may interface with the charging station 104 or backend server 106 to provide a user interface for session initiation, progress monitoring, and alerts. The backend server 106 may further communicate with third-party cloud service 108 and third-party cloud platform 109 components that provide extended capabilities such as payment processing, navigation integration, analytics, or partner interoperability. Data exchanges among these components may occur via encrypted wired or wireless channels, and arrows in FIG. 1 represent bidirectional data flow.

The service layer may provide navigation, market analysis, billing, and operational intelligence services. The infrastructure layer may provide runtime environments, databases, and network monitoring capabilities that maintain service continuity under both online and offline conditions. The application layer may include user-facing and administrative applications, such as a mobile application, an operator interface, and a management console. These components may cooperate to enable automatic authentication, charging control, and safety management for electric-vehicle users.

### AI Facial Recognition Subsystem

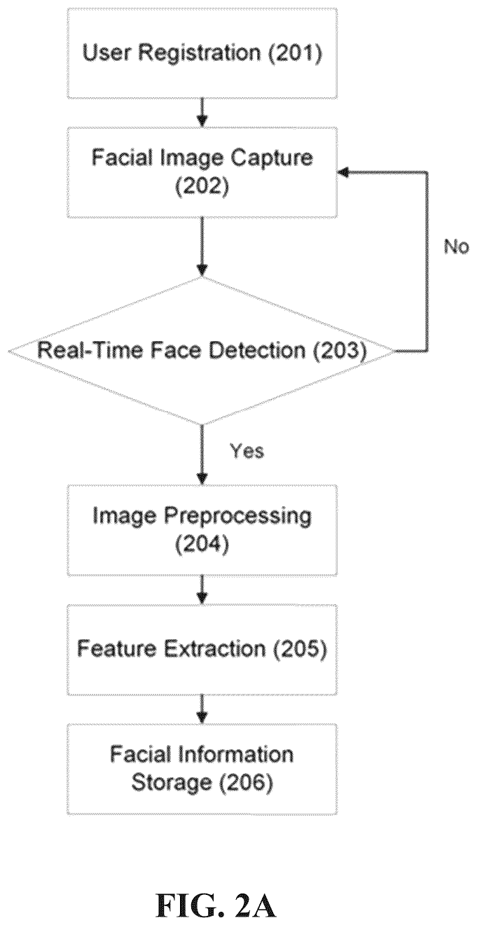

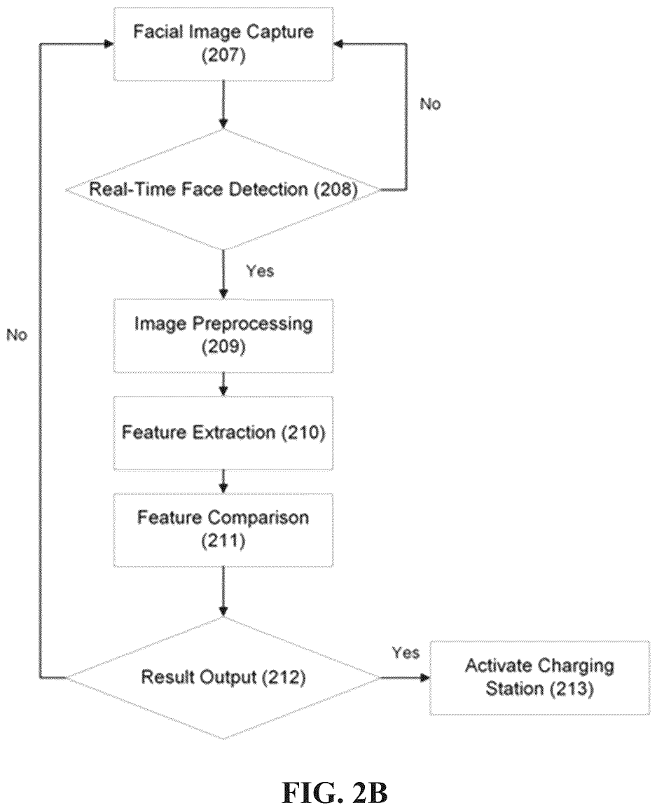

FIG. 2A is a flowchart that illustrates an example embodiment of a facial registration workflow for capturing and storing user facial data in accordance with the systems and methods described herein. FIG. 2B is a flowchart that illustrates an example embodiment of a facial recognition workflow for authenticating a user and enabling a charging session in accordance with the systems and methods described herein. FIGS. 2A and 2B collectively illustrate example workflows corresponding to the method embodiments described herein. Each block or operation shown in these figures may represent one or more substeps or functions that may be implemented in software, hardware, or a combination thereof. In various embodiments, the illustrated workflows may include the substeps of user registration, live image acquisition, image preprocessing, feature-vector generation, identity verification, charging authorization, environmental monitoring, and fire suppression triggering, as recited in the method claims.

Referring to FIG. 2A, in some embodiments, a user registration procedure may be performed through a mobile application that prompts a user to provide identifying information, vehicle data, and payment details. The mobile application may further request one or more facial images, which may be captured using a smartphone camera or an on-site binocular camera associated with the charging station. The captured images may be processed to extract facial feature vectors that may be stored in a secure database for subsequent authentication.

FIG. 2A illustrates an example facial-registration workflow that may include user registration (201), facial image capture (202), real-time face detection (203), image preprocessing (204), feature extraction (205), and facial information storage (206).

User registration (201) may include creation of a user account record containing identifying data such as name, contact information, vehicle identification, and payment details. The registration process may request the user's consent for biometric processing and may display applicable privacy terms. A unique user identifier may be assigned to link the registered account with subsequently captured facial information, and the system may validate the information to prevent duplicate accounts.

Facial image capture (202) may include acquisition of one or more facial images from a client-side device or from a binocular camera located at the charging station. The capture process may use visual or infrared illumination and may provide on-screen or audible guidance to align the user's face within a target frame. Multiple images may be recorded under differing exposure and lighting conditions, and metadata such as timestamp, device type, and orientation may be logged for each capture event.

Real-time face detection (203) may analyze each captured frame to locate facial landmarks and evaluate image quality metrics including brightness, focus, pose, and occlusion. The analysis may also perform liveness verification by comparing stereo-depth consistency or infrared reflectance patterns to reject static photographs or artificial replicas. If the detection results fail to satisfy defined thresholds, the workflow may return to facial image capture (202) to obtain a new image set; otherwise, the process may proceed to image preprocessing (204).

Image preprocessing (204) may standardize the accepted facial image for subsequent analysis. Operations may include cropping the facial region, aligning eye and mouth landmarks, normalizing scale and rotation, equalizing illumination, filtering noise, and converting the image into a standardized color or infrared channel representation. When multiple valid frames are available, the system may select the highest-quality image or may synthesize a composite representation to improve accuracy.

Feature extraction (205) may generate a numerical representation of the face, referred to as a feature vector, using a convolutional neural network or other deep-learning model. The model may transform the preprocessed image into an embedding of fixed length that characterizes stable facial features. The extraction stage may additionally compute auxiliary parameters such as image confidence, liveness probability, or quality metrics, and may compare the new vector to existing templates to prevent duplicate enrollment.

Facial information storage (206) may associate the extracted facial feature vector with the user identifier and store the record within a secure local or remote database. The data may be encrypted during transmission and storage, versioned to accommodate model updates, and assigned retention parameters consistent with privacy requirements. In situations where network connectivity is temporarily unavailable, the system may cache the information locally and automatically synchronize it with the backend database upon restoration of communication, completing the registration workflow.

Referring to FIG. 2B, when a user approaches the charging station 120, the facial recognition camera 110 may capture a live image of the user's face. In some embodiments, the camera 110 may be implemented using a binocular module, such as an M7 Series binocular facial recognition module, which may employ dual infrared sensors to achieve three-dimensional depth perception and enhanced accuracy. The camera 110 may process the image to perform real-time face detection, image enhancement, cropping, and normalization prior to generating a feature vector. The feature vector may be computed using a deep-learning convolutional neural network (CNN) trained to identify human facial patterns with high precision.

FIG. 2B illustrates an example facial-recognition workflow that may include facial image capture (207), real-time face detection (208), image preprocessing (209), feature extraction (210), feature comparison (211), result output (212), and activation of the charging station (213).

Facial image capture (207) may occur when a user approaches the charging station and enters the recognition zone of the camera. The camera may continuously acquire image frames in both visible and infrared spectra and may adjust exposure, gain, and focus automatically to maintain image quality under variable lighting. Metadata such as timestamp, ambient-light level, and distance estimation may be appended to each frame. The capture process may repeat until a valid facial region is detected.

Real-time face detection (208) may analyze each incoming frame to identify the presence of one or more faces and to verify that the captured subject meets geometric and quality constraints. The analysis may employ deep neural-network models optimized for low-latency inference and may apply liveness analysis through stereo-depth consistency and near-infrared texture inspection. When no valid detection is made, the workflow may loop back to facial image capture (207) for continued acquisition until the detection result satisfies defined criteria.

Image preprocessing (209) may normalize the detected face region by performing operations such as cropping, alignment to canonical eye and mouth landmarks, histogram equalization, de-noising, and conversion into the input tensor format required by the recognition network. The preprocessing sequence may execute within the camera module or within a local controller to reduce transmission bandwidth and to ensure consistent feature generation under varying environmental conditions.

Feature extraction (210) may generate a facial embedding or feature vector using a convolutional neural network trained on representative datasets. The generated vector may encapsulate spatial and textural facial attributes in a compact numeric representation. Additional calculations may include image confidence scoring, anti-spoofing verification results, and environmental indicators that may later be logged with the recognition transaction.

Feature comparison (211) may compare the newly generated feature vector with stored feature data associated with registered users. The comparison may employ cosine-similarity or Euclidean-distance metrics and may apply thresholding rules determined during system calibration. When the computed similarity score exceeds a predefined acceptance level, the system may classify the user as positively identified; otherwise, the process may revert to facial image capture (207) for another recognition attempt.

Similarity decisioning may include adaptive thresholding that may be tuned per installation based on ambient lighting, anticipated presentation-attack risk, and observed operating conditions to balance false-accept and false-reject rates over time.

Result output (212) may generate an authentication result record containing the user identifier, confidence score, time, and device location. The record may be transmitted securely to a controller or backend server for logging and authorization. If the result corresponds to a positive identification, the workflow may continue to activation of the charging station (213); otherwise, the system may notify the user or request an alternative authentication method.

Activate charging station (213) may include transmission of an enable-signal from the controller to the power-delivery circuitry of the charging station. The signal may unlock or energize the charging connector, initialize energy metering, and begin current flow to the vehicle. During the active session, the controller may continue environmental monitoring and, if abnormal temperature or fault conditions are detected, may coordinate with the fire suppression subsystem to execute the protective response described elsewhere herein.

The binocular facial recognition module may include a processor that executes neural network inference algorithms and may complete a recognition sequence in less than one second, for example approximately 0.3 seconds, depending on system configuration. The recognition rate may achieve a true acceptance rate above 98 percent at a false acceptance rate below one in 100,000. The module may operate effectively over a distance ranging from approximately 0.4 meters to 1.0 meter and may include anti-spoofing capability to distinguish a live subject from a photograph, mask, or replayed image. The module may communicate with a local controller or the backend server 140 through a serial communication interface, such as a Universal Asynchronous Receiver-Transmitter (UART) channel, and may utilize encrypted data exchange based on symmetric-key generation.

In some embodiments, the camera 110 may employ two complementary metal-oxide semiconductor (CMOS) image sensors, each having a resolution of approximately 640 by 480 pixels and configured for operation with an infrared illumination source at about 850 nanometers. The camera 110 may include an optical field of view of approximately 54 degrees horizontally and 68 degrees vertically, enabling reliable detection across typical human height ranges when the camera is mounted at approximately 1.2 meters above ground level and inclined downward by about 25 degrees. A fill-in light may be provided adjacent to the camera lens to enhance illumination during low-light operation. The facial recognition subsystem may remain functional over an ambient temperature range extending from approximately −20° C. to +60° C. and may include electrostatic discharge protection up to +8 kilovolts for outdoor environments.

The M7 Series binocular facial recognition module described herein is provided merely as one non-limiting example of a suitable imaging and processing device. Equivalent modules, components, or assemblies from other manufacturers that perform substantially similar functions, such as three-dimensional imaging, infrared illumination, neural-network-based feature extraction, and anti-spoofing analysis—may be substituted without departing from the scope of the disclosed embodiments.

After the AI camera 110 verifies a user identity, the backend server 140 may authorize the activation of the charging station 120. The charging station 120 may then enable power delivery to the connected vehicle automatically, without requiring user contact with a physical card or mobile device. The mobile terminal 160 may provide real-time status information such as charging progress, energy delivered, and account billing.

Cable Secured Compartment Extension. In some embodiments, the charging station may further include a cable secured compartment extension configured to enhance operational safety, deter misuse, and automate session control. The cable secured compartment may include a housing or cabinet extension attached to a body of the direct current fast charging (DCFC) unit. One or more access doors of the compartment may be mechanically or electromechanically locked and configured to open only when the charging system is activated via an Open Charge Point Protocol (OCPP) command or a point-of-sale (POS) device authorization. This controlled access inhibits removal or connection of a charging cable except during an authorized charging session.

When a user is authenticated and the charger is enabled, a controller may transmit an unlock signal to release the compartment door, thereby allowing access to the charging cable. The user may then connect the cable to a vehicle inlet to initiate or continue the charging session. Upon completion of charging, or when the user returns the cable to the compartment and closes the door, a door-closure sensor may detect that the cable has been stowed. Closure of the door may complete a physical or electronic circuit that issues a termination signal to the controller, which in turn transmits an OCPP message indicating that the charging session is complete. This arrangement automatically terminates billing and power delivery when the cable is secured, and may prevent unauthorized reuse or environmental exposure of energized conductors.

The cable secured compartment extension may include one or more safety interlocks-such as limit switches, magnetic reed sensors, latch-position encoders, or optical detectors-configured to confirm proper cable placement prior to permitting door closure. In some implementations, the compartment may further include temperature and/or smoke sensors integrated with the fire suppression subsystem to provide early detection of overheating within the cable area, with interlocks that inhibit re-enablement until temperatures return to a safe range.

In some embodiments, the compartment extension may be constructed of weather-resistant materials, maintain an ingress-protection rating of IP54 or higher, and optionally incorporate internal illumination and/or low-power heaters to support cold-weather operation. The controller may log door-open, door-closed, and cable-present events with timestamps for audit and maintenance purposes and may continue to enforce the interlocks during offline operation, synchronizing state changes and OCPP session messages when connectivity is restored.

### Fire Suppression Subsystem

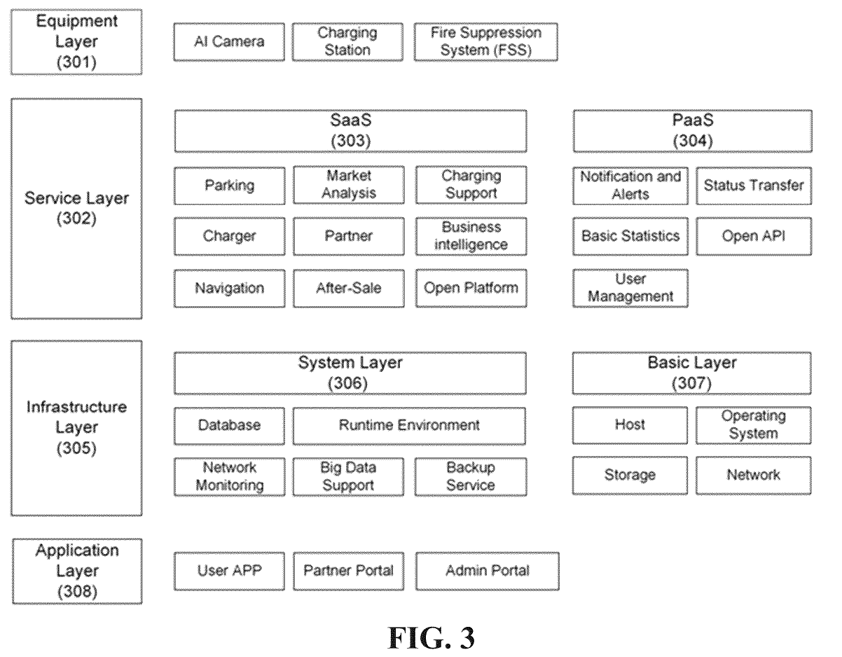

FIG. 3 is a diagram that illustrates an example embodiment of a system architecture showing interaction among multiple functional layers of the electric-vehicle charging system. The illustrated architecture may include an equipment layer 301, a service layer 302, an infrastructure layer 305, and an application layer 308, each providing specific roles in system operation and management.

In the illustrated embodiment, the equipment layer 301 may include the artificial-intelligence camera, the charging station, and the fire suppression subsystem; the service layer 302 may provide Software-as-a-Service 303 and Platform-as-a-Service 304 functions; the infrastructure layer 305 may include a system layer 306 and a basic layer 307; and the application layer 308 may present user and administrative interfaces.

The service layer 302 may host software-as-a-service (SaaS) 303 and platform-as-a-service (PaaS) 304 functions. SaaS 303 may include modules for parking, navigation, charger management, partner coordination, market analysis, charging support, after-sale service, business intelligence, and an open platform interface that exposes standardized APIs. PaaS 304 may provide notification and alerts, status transfer, basic statistics, user management, and open API capabilities that allow third-party integration.

The infrastructure layer 305 may comprise a system layer 306 and a basic layer 307. The system layer 306 may include components such as a database, runtime environment, network monitoring, big-data support, and backup service that collectively maintain high availability and data integrity. The basic layer 307 may include computing resources such as host hardware, an operating system, storage, and network infrastructure that provide foundational computing capability for all upper layers.

At the top, the application layer 308 may present interfaces such as a user application (APP), a partner portal, and an admin portal. These applications may provide access for end users, maintenance personnel, and business partners to view charging status, configure stations, retrieve analytics, or administer system parameters. Information flow among the layers may be bidirectional: data generated by the equipment layer 301 may be aggregated by the service layer 302 and stored in the infrastructure layer 305, while control commands or updates from the application layer 308 may propagate downward to manage physical devices in the equipment layer 301.

The extinguishing mechanism may rely on a combination of endothermic decomposition and chemical inhibition in both gas and solid phases. When activated, the extinguishing composition may release aerosol particles that absorb heat and chemically interfere with flame propagation. The metal oxides and carbonates in the composition may undergo endothermic decomposition to absorb heat from the combustion zone, while metal ions such as potassium or strontium may react with reactive free radicals (H^{·}, OH^{·}, and O^{·}) present in the flame, thereby terminating chain reactions and suppressing combustion.

The aerosol device may be activated either electrically or thermally. In an electrically triggered embodiment, the charging controller may provide a low-voltage direct current signal, for example between approximately 1.5 volts and 24 volts, to initiate the discharge. In a thermally triggered embodiment, a heat-sensitive wire may activate the composition when the temperature exceeds a threshold in the range of approximately 160° C. to 180° C. Upon activation, the composition may generate a dense aerosol cloud that disperses within the protected volume to extinguish flames and prevent re-ignition.

In some embodiments, each aerosol device may contain approximately 100 grams of extinguishing material, sufficient to protect a volume of up to approximately three cubic meters. The device may provide a discharge delay of less than five seconds after activation and may function within an ambient temperature range from approximately −40° C. to +85° C. The device may be installed using fasteners such as M4 screws and may include an electrical feedback circuit configured as a normally-open contact to provide status information to the controller. The overall assembly may have a mass of about 1.4 kilograms and a service life of approximately ten years.

The extinguishing mechanism may further include both gas-phase and solid-phase inhibition effects. In the gas phase, vaporized metal ions may react with active radicals to form stable compounds such as SrO or KOH, thereby suppressing combustion. In the solid phase, aerosol particles may adsorb and catalyze the recombination of radicals, converting them into non-reactive molecules. The combined cooling and inhibition effects may rapidly reduce flame temperature and extinguish fires in battery compartments, DC fast-charging enclosures, or other confined spaces associated with the charging station.

In some embodiments, the reactive species within the aerosol composition may include metal ions such as potassium (K⁺), strontium (Sr²⁺), or magnesium (Mg²⁺), which may chemically combine with reactive radicals generated during combustion. For example, potassium ions may react with hydroxyl radicals according to K+OH→KOH, strontium ions may react with oxygen radicals to form SrO, and magnesium ions may form MgO through Mg+O→MgO. These reactions may convert high-energy radicals into stable oxides and hydroxides, thereby terminating chain reactions in both gas and solid phases and enhancing the suppression efficiency of the aerosol discharge.

### Integration and Operation

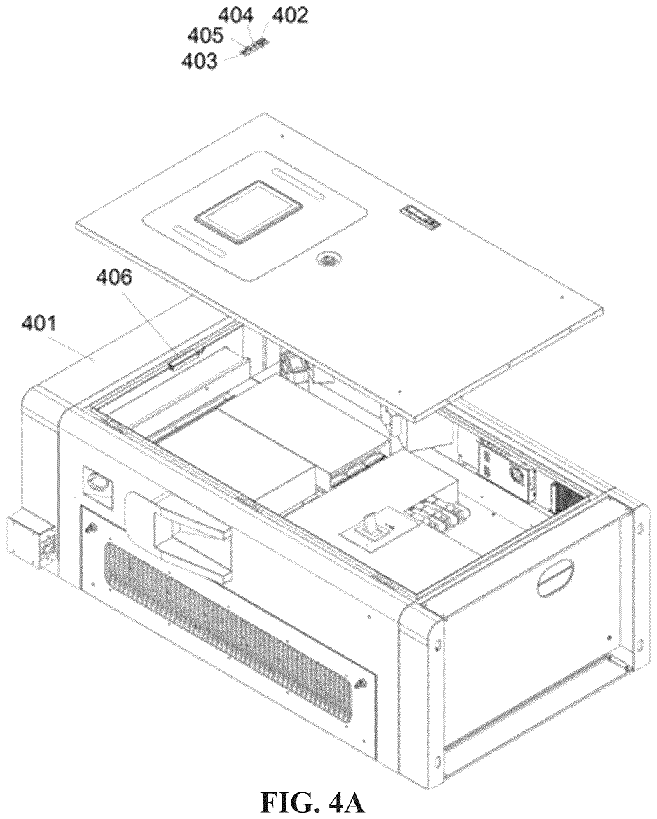

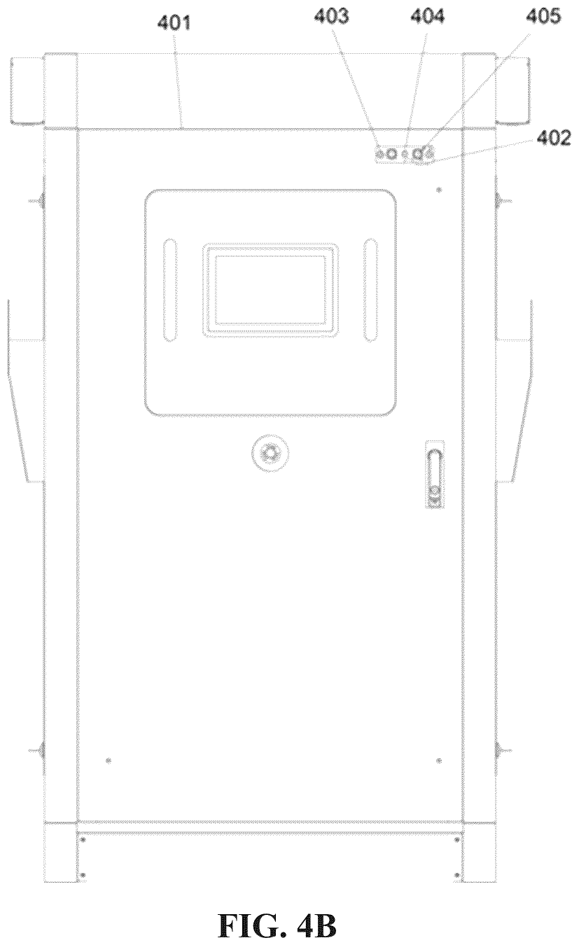

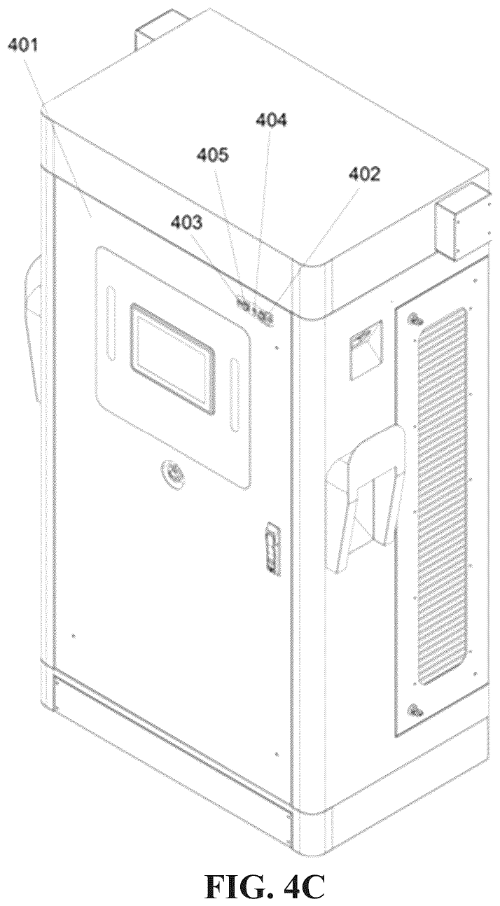

Referring to FIGS. 4A-4C, the AI camera 402 may be mounted on a frontal surface of the charging station 401. A fill-in light 404 may be positioned near the camera lens 405 to maintain illumination, and the fire suppression device 406 may be mounted within the interior cavity of the charger in proximity to high-current components. A mounting bracket 403 may support the camera 402 and the fill-in light 404, providing a fixed optical alignment and environmental sealing at the charging-station interface. The camera 402 and the fire suppression subsystem 406 may both be connected to a controller located within the charging station 120, which may coordinate facial recognition, charging initiation, environmental monitoring, and fire suppression functions.

During use, a registered user may approach the charging station 120. The AI camera 402 may capture a facial image and perform recognition locally or through the backend server 140. Upon a positive match, the controller may enable charging. While charging proceeds, temperature and environmental sensors may continuously monitor the enclosure. When a temperature increase indicative of a thermal fault is detected, the controller may send a trigger signal to the fire suppression subsystem 406, initiating the aerosol discharge sequence. The system may also transmit a fire-event alert to the backend server 140 and to the user's mobile application, enabling remote awareness and incident logging.

The control workflow may execute entirely at the edge within a charging-station controller, or portions that are not time-critical may be partitioned to a backend analytics service while real-time interlocks and actuation paths remain local to satisfy response-time requirements.

The charging system 100 may remain functional during temporary network interruptions. When operating in an offline mode, the local storage unit 150 may record transaction and event data for subsequent synchronization with the backend server 140 once communication is restored. This design may enable continuous service availability and accurate post-session data reconciliation.

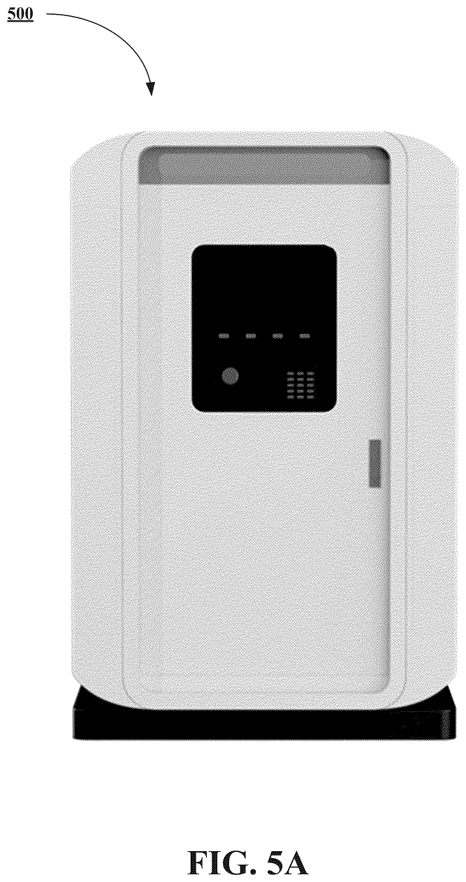

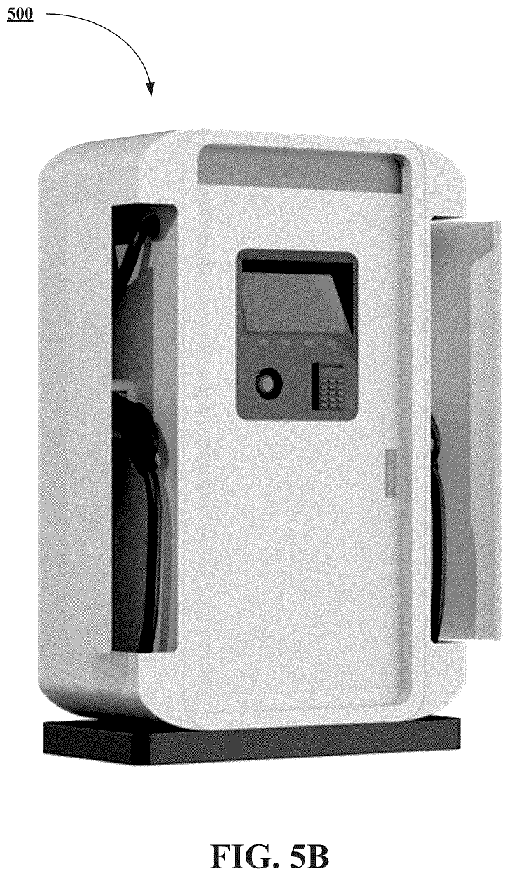

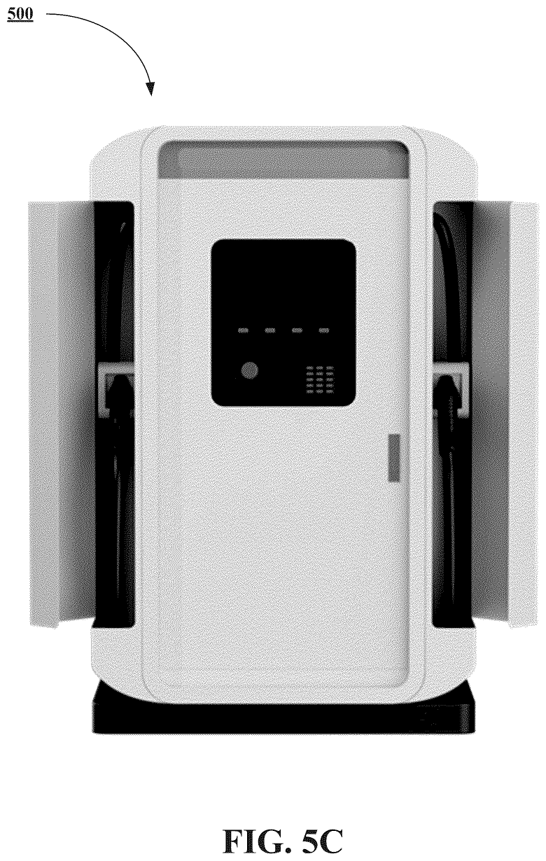

FIGS. 5A-5C illustrate example embodiments of a cable secured compartment extension 500 configured for integration with a direct current fast-charging (DCFC) station. The extension 500 provides an enclosed space for storing and securing one or more charging cables when not in use, thereby reducing trip hazards, preventing environmental exposure, and enabling controlled access linked to software authorization mechanisms such as Open Charge Point Protocol (OCPP) or a point-of-sale (POS) device.

Referring first to FIG. 5A, the illustrated embodiment shows a DCFC body extension having a front access door defining a closed compartment for internal storage of one or more charging cables. The extension 500 may be formed as an integral part of the charging-station housing or as an attachable module that couples mechanically to the main charger enclosure. The front door may include a sealed perimeter and hinge assembly providing ingress protection of at least IP54 for outdoor operation. A door-status indicator or illumination band may be disposed across the upper portion of the housing to communicate operational states such as “available,” “in use,” or “locked.”

When the system controller receives a valid user-authentication signal (for example, via facial-recognition authorization, mobile-application command, or POS transaction), the controller may generate an OCPP “unlock connector” command that releases an electromechanical latch associated with the compartment door. This allows the user to open the compartment and access the stored cable. The cable may then be removed and connected to the vehicle inlet to initiate charging. During the active session, the controller may continuously monitor the door state and cable presence through position sensors or limit switches.

As shown schematically in FIG. 5B, the compartment may include one or more internal cable guides, hangers, or retracting mechanisms configured to route the charging cables into a coiled or stowed position when the session ends. A sensor array—comprising, for example, magnetic reed switches or optical detectors—may verify that the cable is fully returned to its holder before enabling the door to close. Closure of the door may complete a closed-circuit feedback path that transmits a “session complete” signal to the controller. In response, the controller may issue a corresponding OCPP “transaction stop” message, deactivate the power-delivery contactor, and safely terminate billing.

FIG. 5C depicts the compartment in the closed and locked state following reinsertion of the charging cable. The locking mechanism may be a solenoid latch, electromechanical cam lock, or magnetic actuator that automatically engages upon receipt of the termination signal. The controller may record a time-stamped event log containing door-open, cable-inserted, and door-closed states for diagnostic and audit purposes. In certain embodiments, the compartment may further incorporate temperature or smoke sensors integrated with the fire-suppression subsystem to detect thermal anomalies in the cable storage area.

The extension 500 may be fabricated from corrosion-resistant sheet metal or molded polymer with internal reinforcement and insulation to withstand temperature fluctuations between −40° C. and +85° C. Optional features may include an interior LED light, low-power heater pad, or humidity-absorbing cartridge to maintain cable flexibility and prevent condensation. The cable secured compartment extension thus provides a mechanically robust and electronically interlocked storage system that automates session control, enhances safety, and supports compliance with OCPP transaction workflows.

Fire suppression control workflow overview may include environmental signal acquisition, signal validation and filtering, threshold evaluation with hysteresis, decision logic and interlocks, discharge sequencing, post-discharge enclosure management, and event recording with reset authorization.

Environmental signal acquisition may include periodic sampling of temperature sensors, current/voltage sensors associated with power electronics, and optional smoke or particulate sensors within a charger enclosure. Sampling cadence may be selected to bound detection latency while limiting power consumption, and timestamps may be recorded for each sample to enable temporal correlation with charging events.

Signal validation and filtering may include sensor plausibility checks, outlier rejection, moving-average smoothing, and derivative estimation to identify rapid temperature rise. Validation may further include cross-sensor correlation that may reject a single failed sensor and may rely on a quorum of sensors prior to proceeding to threshold evaluation.

Threshold evaluation with hysteresis may compare validated measurements to one or more configurable thresholds representing caution, warning, and critical states. Hysteresis bands may be applied to reduce chatter around a boundary, and time-over-threshold windows may be used to distinguish transient spikes from sustained hazardous conditions.

Decision logic and interlocks may include confirmation that the enclosure is closed, that a discharge path is unobstructed, and that a maintenance lockout is not engaged. Logic may also include a pre-discharge notification to a backend service or local annunciator when connectivity or power budget permits, without delaying a critical response.

Discharge sequencing may include removal of charging power through a contactor or solid-state switch, isolation verification, issuance of an electrical trigger to the aerosol device, and confirmation of discharge via a feedback loop. Timing may be coordinated so that isolation is achieved prior to aerosol release to reduce the likelihood of re-ignition.

Post-discharge enclosure management may include initiation of an enclosure cool-down interval, optional operation of a ventilation path when present, verification that temperatures have returned to a safe range, and suppression of automatic re-enablement until a service acknowledgement has been recorded.

Event recording and reset authorization may include writing a tamper-evident log entry that may contain timestamps, sensor values, device identifiers, and discharge status, followed by a requirement for a service credential to clear the event and authorize installation of a replacement aerosol device.

Security model for biometric templates and control firmware may include at-rest encryption of facial templates and transaction records using keys stored within a hardware-backed secure element, encrypted transport for recognition and authorization messages, and role-based access control for administrative operations. Firmware integrity may be maintained through secure-boot validation and update packages that may be signed by a trusted certificate, with rollback protection to prevent downgrade attacks.

Privacy controls may include configuration of retention periods for biometric templates and event logs, user-initiated deletion requests that may propagate to all synchronized storage locations, and redaction of personally identifying information from maintenance logs. A template version identifier may be stored to permit re-enrollment when model architecture changes without compromising prior template security.

Offline synchronization behavior may include maintenance of an append-only write-ahead log for authorization outcomes, energy metering data, and safety events. Synchronization may use idempotent transaction identifiers, conflict-resolution rules that may prioritize the latest confirmed authorization, and exponential backoff with jitter to manage repeated attempts under intermittent connectivity.

Health monitoring and diagnostics may include a watchdog that may supervise critical processes, periodic self-test routines for camera illumination, depth sensing, and sensor continuity, and calibration prompts when face-alignment confidence degrades. Diagnostic results may be reported to a backend service or displayed locally for service personnel.

Electrical and power-path integration may include a controller that may command a contactor or solid-state switch, read a vehicle-interface pilot signal through a measurement circuit, and enforce an interlock requiring a positive authentication result prior to energizing a power stage. Isolation status and ground-fault indicators may be monitored continuously during charging, and a fault may trigger immediate de-energization and transition to the fire suppression decision logic.

Mechanical and environmental configuration may include an outdoor-rated enclosure, internal heating or defogging elements for cold environments, hydrophobic or oleophobic coatings on a camera window to maintain optical clarity, and vibration-resistant mounting for the aerosol device. Camera placement may be selected to maintain the target capture distance while minimizing glare from ambient lighting.

Deployment topology may include an edge-centric configuration in which recognition and safety decisions may execute within the charging station controller, a cloud-assisted configuration in which a backend may perform template management and analytics with local fallback, or a fleet configuration in which multiple charging stations may share a local gateway that may provide caching, synchronization, and coordinated safety policy enforcement across colocated equipment.

Sensor redundancy may be provided through spatially separated temperature probes positioned proximate to a power-module heat sink and a cable termination, and a voting scheme may require agreement among at least two sensors before a critical alarm is asserted.

Environmental sealing for the camera window may include a replaceable hydrophobic cover plate retained by a gasketed bezel to maintain an ingress-protection rating of IP54 or higher, and a maintenance routine may prompt cleaning when a glare index or edge-contrast metric falls below a defined threshold.

The aerosol agent selection may address at least Class A, B, C, and energized-equipment fires, and enclosure materials adjacent to the protected volume may be selected for compatibility with expected aerosol byproducts to reduce corrosion potential on copper busbars and plated fasteners.

End-to-end response time from threshold crossing to initiation of agent discharge may be bounded to five seconds or less under nominal conditions, and measured detection latency and actuation latency may be recorded for each event to support post-incident analysis and maintenance.

### VARIANTS AND ALTERNATIVE EMBODIMENTS

In alternative embodiments, a single-camera configuration may perform both facial recognition and license-plate identification, while a dual-camera arrangement may be used in high-traffic environments to increase throughput. In environments where facial recognition may be unreliable due to lighting conditions, an alternative authentication method, such as a mobile application-based quick response (QR) code scan, may be implemented.

The fire suppression subsystem 130 may also be adapted to installations of different sizes by varying the number and placement of aerosol modules. Multiple devices may be distributed throughout a large charging cabinet or array to achieve complete coverage. Additional sensors, such as smoke detectors or infrared temperature sensors, may be included to enhance early fire detection and reduce response time.

The described embodiments provide a secure, autonomous, and safety-enhanced electric vehicle charging solution that may be applied in public charging stations, fleet depots, or residential installations. The integration of AI-based authentication and hot-aerosol fire suppression may improve operational safety, reduce maintenance, and enhance user experience compared to conventional charging systems.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An electric vehicle charging system, comprising:
a charging station configured to provide electrical energy to an electric vehicle;
an artificial-intelligence facial recognition camera communicatively coupled to the charging station and configured to capture a facial image of a user;
a controller configured to compare a facial feature vector derived from the facial image to a stored feature vector associated with a registered user and to enable the charging station responsive to a positive match; and
a fire suppression subsystem integrated within the charging station and configured to discharge an aerosol-based extinguishing agent into an interior volume when a thermal condition indicative of a fire event is detected.

2. The system of claim 1, wherein the fire suppression subsystem comprises a hot-aerosol fire extinguishing device that may be activated electrically or thermally.

3. The system of claim 1, wherein the fire suppression subsystem comprises an aerosol composition that cools a combustion region by endothermic decomposition and inhibits chain reactions in both gas and solid phases.

4. The system of claim 1, wherein the controller is further configured to receive sensor data from one or more temperature sensors disposed within the charging station and to trigger activation of the fire suppression subsystem when a sensed temperature exceeds a predetermined threshold.

5. The system of claim 1, wherein the artificial-intelligence facial recognition camera comprises a binocular imaging module having dual infrared sensors configured to capture three-dimensional facial data.

6. The system of claim 5, wherein the binocular imaging module comprises a convolutional neural network configured to generate the facial feature vector and to perform anti-spoofing analysis to reject presentation of two-dimensional images or masks.

7. The system of claim 1, wherein the controller is further configured to operate in an offline mode in which transaction data and authentication data are stored locally and synchronized with a backend server when network connectivity is restored.

8. The system of claim 1, further comprising a user interface application configured to display charging progress and fire-event notifications on a user mobile device.

9. The system of claim 1, wherein the fire suppression subsystem comprises at least one aerosol cartridge containing approximately 100 grams of extinguishing material capable of protecting a volume of up to about three cubic meters.

10. The system of claim 1, wherein the charging station further comprises an illumination component positioned adjacent to the artificial-intelligence facial recognition camera to enhance facial image quality in low-light environments.

11. The system of claim 1, wherein the charging station further comprises a secured cable compartment having one or more access doors configured to open responsive to activation of a charging session and to terminate the charging session upon reinsertion of a charging cable and closure of the doors, wherein closure generates a closed-circuit signal that causes the controller to transmit a session-complete command to Open Charge Point Protocol (OCPP) software.

12. A method for operating an electric vehicle charging system comprising an artificial-intelligence facial recognition subsystem and a fire suppression subsystem, the method comprising:
receiving a registration of a user including facial image data and vehicle information;
capturing, by the facial recognition subsystem, a live facial image of the user proximate to a charging station;
generating a facial feature vector from the live facial image using a convolutional neural network;
comparing the facial feature vector to stored facial feature data associated with the registered user;
enabling charging responsive to a match between the facial feature vector and the stored facial feature data; and
activating the fire suppression subsystem to discharge an aerosol extinguishing agent when a fire condition is detected within or near the charging station.

13. The method of claim 12, wherein the step of capturing comprises obtaining three-dimensional facial data using dual infrared image sensors.

14. The method of claim 12, wherein the step of generating the facial feature vector comprises preprocessing the live facial image through enhancement, cropping, and normalization operations.

15. The method of claim 12, further comprising storing transaction and authentication data locally during a network interruption and synchronizing the data with a backend database upon restoration of connectivity.

16. The method of claim 12, further comprising detecting a temperature increase or electrical fault using one or more environmental sensors and triggering the aerosol discharge responsive to the detection.

17. The method of claim 12, further comprising transmitting a fire-event notification to a user mobile application and to a backend monitoring system when the fire suppression subsystem is activated.

18. A non-transitory computer-readable medium storing instructions that, when executed by one or more processors of an electric vehicle charging system, cause the one or more processors to:
process facial image data captured by an artificial-intelligence facial recognition camera to generate a facial feature vector;
compare the facial feature vector to stored feature data to determine user identity;
enable a charging function responsive to successful user identification; and
monitor environmental parameters and initiate activation of a fire suppression subsystem to discharge an aerosol-based extinguishing agent when a thermal condition exceeds a threshold.

19. The medium of claim 18, wherein execution of the instructions further causes generation of anti-spoofing features to distinguish live images from static representations.

20. The medium of claim 18, wherein execution of the instructions further causes local caching of transaction data during an offline mode and synchronization with a remote server upon re-establishment of network connectivity.
